(19) United States
(12) Patent Application Publication
(10) Pub. No.: US 2012/0303355 A1
(43) Pub. Date: Nov. 29, 2012

(54) Method and System for Text Message Normalization Based on Character Transformation and Web Data

(75) Inventors: Fei Liu, Palo Alto, CA (US); Fuliang Weng, Mountain View, CA (US)

(73) Assignee: ROBERT BOSCH GMBH, Stuttgart (DE)

(21) Appl. No.: 13/117,330

(22) Filed: May 27, 2011

(51) Int. Cl. G06F 17/27

(52) U.S. Cl. 704/9

(57) ABSTRACT

A method for generating non-standard tokens that correspond to standard tokens used in speech synthesis systems has been developed. The method includes selecting a standard token from a plurality of standard tokens stored in memory, using a random field model to select a predetermined operation to perform on each character in the selected token, performing the selected operation on each character to generate an output token, and storing the output token in the memory in association with the selected token. The output token is different from each token in the plurality of standard tokens.

### TECHNICAL FIELD

This disclosure relates generally to the fields of natural language processing and text normalization, and, more specifically, to systems and methods for normalizing text prior to speech synthesis or other analysis.

### BACKGROUND

The field of mobile communication has seen rapid growth in recent years. Due to growth in the geographic coverage and bandwidth of various wireless networks, a wide variety of portable electronic devices, which include cellular telephones, smart phones, tablets, portable media players, and notebook computing devices, have enabled users to communicate and access data networks from a variety of locations. These portable electronic devices support a wide variety of communication types including audio, video, and text-based communication. Portable electronic devices that are used for text-based communication typically include a display screen, such as an LCD or OLED screen, which can display text for reading.

The popularity of text-based communications has surged in recent years. Various text communication systems include, but are not limited to, the Short Message Service (SMS), various social networking services, which include Facebook and Twitter, instant messaging services, and conventional electronic mail services. Many text messages sent using text communication services are of relatively short length. Some text messaging systems, such as SMS, have technical limitations that require messages to be shorter than a certain length, such as 160 characters. Even for messaging services that do not impose message length restrictions, the input facilities provided by many portable electronic devices, such as physical and virtual keyboards, tend to be cumbersome for inputting large amounts of text. Additionally, users of mobile messenger devices, such as adolescents, often compress messages using abbreviations or slang terms that are not recognized as canonical words in any language. For example, terms such a “BRB” stand for longer phrases such as “be right back.” Users may also employ non-standard spellings for standard words, such as substituting the word “cause” with the non-standard “kuz.” The alternative spellings and word forms differ from simple misspellings, and existing spell checking systems are not equipped to normalize the alternative word forms into standard words found in a dictionary. The slang terms and alternative spellings rely on the knowledge of other people receiving the text message to interpret an appropriate meaning from the text.

While the popularity of sending and receiving text messages has grown, many situations preclude the recipient from reading text messages in a timely manner. In one example, a driver of a motor vehicle may be distracted when attempting to read a text message while operating the vehicle. In other situations, a user of a portable electronic device may not have immediate access to hold the device and read messages from a screen on the device. Some users are also visually impaired and may have trouble reading text from a screen on a mobile device. To mitigate these problems, some portable electronic devices and other systems include a speech synthesis system. The speech synthesis system is configured to generate spoken versions of text messages so that the person receiving a text message does not have to read the message. The synthesized audio messages enable a person to hear the content of one or more text messages while preventing distraction when the person is performing another activity, such as operating a vehicle.

While speech synthesis systems are useful in reading back text for a known language, speech synthesis becomes more problematic when dealing with text messages that include slang terms, abbreviations, and other non-standard words used in text messages. The speech synthesis systems rely on a model that maps known words to an audio model for speech synthesis. When synthesizing unknown words, many speech synthesis systems fall back to imperfect phonetic approximations of words, or spell out words letter-by-letter. In these conditions, the output of the speech synthesis system does not follow the expected flow of normal speech, and the speech synthesis system can become a distraction. Other text processing systems, including language translation systems and natural language processing systems, may have similar problems when text messages include non-standard spellings and word forms.

While existing dictionaries may provide translations for common slang terms and abbreviations, the variety of alternative spellings and constructions of standard words that are used in text messages is too broad to be accommodated by a dictionary compiled from standard sources. Additionally, portable electronic device users are continually forming new variations on existing words that could not be available in a standard dictionary. Moreover, the mapping from standard words to their nonstandard variations is many-to-many, that is, a nonstandard variation may correspond to different standard word forms and vice versa. Consequently, systems and methods for predicting variations of standard words to enable normalization of alternative word forms to standard dictionary words would be beneficial.

### SUMMARY

In one embodiment, a method for generating non-standard tokens from a standard token stored in a memory has been developed. The method includes selecting a standard token from a plurality of standard tokens stored in the memory, the selected token having a plurality of input characters, selecting an operation from a plurality of predetermined operations in accordance with a random field model for each input character in the plurality of input characters, performing the selected operation on each input character to generate an output token that is different from each token in the plurality of standard tokens, and storing the output token in the memory in association with the selected token.

In another embodiment, a method for generating operational parameters for use in a random field model has been developed. The method includes comparing each token in a first plurality of tokens stored in a memory to a plurality of standard tokens stored in the memory, identifying a first token in the first plurality of tokens as a non-standard token in response to the first token being different from each standard token in the plurality of standard tokens, identifying a second token in the first plurality of tokens as a context token in response to the second token providing contextual information for the first token, generating a database query including the first token and the second token, querying a database with the generated query, identifying a result token corresponding to the first token from a result obtained from the database, and storing the result token in association with the first token in a memory.

In another embodiment a system for generating non-standard tokens from standard tokens has been developed. The system includes a memory, the memory storing a plurality of standard tokens and a plurality of operational parameters for a random field model and a processing module operatively connected to the memory. The processing module is configured to obtain the operational parameters for the random field model from the memory, generate the random field model from the operational parameters, select a standard token from the plurality of standard tokens in the memory, the selected standard token having a plurality of input characters, select an operation from a plurality of predetermined operations in accordance with the random field model for each input character in the plurality of input characters for the selected standard token, perform the selected operation on each input character in the selected standard token to generate an output token that is different from each standard token in the plurality of standard tokens, and store the output token in the memory in association with the selected standard token.

### BRIEF DESCRIPTION OF THE DRAWINGS

FIG. 1 is a schematic diagram of a system for generating non-standard tokens corresponding to standard tokens using a conditional random field model and for synthesizing speech from text including the standard tokens and the non-standard tokens.

FIG. 2 is a block diagram of a process for generating non-standard tokens from a standard token using a conditional random field model.

FIG. 3 depicts examples of operations between characters in various standard tokens and corresponding non-standard tokens.

FIG. 4 is a schematic diagram of the system of FIG. 1 configured to generate queries for a database and receive results from the database to associate non-standard tokens with known. standard tokens used for training of a conditional random field model.

FIG. 5 is a block diagram of a process for generating training data and for training a conditional random field model.

FIG. 6A is an example of a database query formatted as search terms for a search engine including a non-standard token.

FIG. 6B depicts the terms from the database query of FIG. 6A aligned along a longest common sequence of characters with a candidate token.

FIG. 7 is a block diagram of a process for replacing non-standard tokens in a text message with standard tokens and for generating synthesized speech corresponding to the text message.

FIG. 8 depicts an alternative configuration of the system depicted in FIG. 1 that is configured for use in a vehicle.

FIG. 9 is a graph of a prior-art conditional random field model.

### DETAILED DESCRIPTION

For the purposes of promoting an understanding of the principles of the embodiments disclosed herein, reference is now be made to the drawings and descriptions in the following written specification. No limitation to the scope of the subject matter is intended by the references. The present disclosure also includes any alterations and modifications to the illustrated embodiments and includes further applications of the principles of the disclosed embodiments as would normally occur to one skilled in the art to which this disclosure pertains.

As used herein, the term “token” refers to an individual element in a text that may be extracted from the text via a tokenization process. Examples of tokens include words separated by spaces or punctuation, such as periods, commas, hyphens, semicolons, exclamation marks, question marks and the like. A token may also include a number, symbol, combination of words and numbers, or multiple words that are associated with one another. A “standard token” is a token that is part of a known language, including English and other languages. A dictionary stored in the memory of a device typically includes a plurality of standard tokens that may correspond to one or more languages, including slang tokens, dialect tokens, and technical tokens that may not have universal acceptance as part of an official language. In the embodiments described herein, the standard tokens include any token that a speech synthesis unit is configured to pronounce aurally when provided with the standard token as an input. A non-standard token, sometimes called an out-of vocabulary (OOV) token, refers to any token that does not match one of the standard tokens. As used herein, a “match” between two tokens refers to one token having a value that is equivalent to the value of another token. One type of match occurs between two tokens that each have an identical spelling. A match can also occur between two tokens that do not have identical spellings, but share common elements following predetermined rules. For example, the tokens “patents” and “patent” can match each other where “patents” is the pluralized form of the token “patent.”

The embodiments described herein employ a conditional random field model to generate non-standard tokens that correspond to standard tokens to enable speech synthesis and other operations on text messages that include non-standard tokens. The term “conditional, random field” (CRF) refers to a probabilistic mathematical model that includes an undirected graph with vertices connected by edges. More generally, the term “random field model” as used herein refers to various graphical models that include a set of vertices connected by edges in a graph. Each vertex in the graph represents a random variable, and edges represent dependencies between random variables. Those having ordinary skill in the art will recognize that other random fields, including but not limited to Markov random field models and hidden Markov random field models, are suitable for use in alternative embodiments. As used herein, the term “feature” as applied to a token refers to any linguistically identifiable component of the token and any measurable heuristic properties of the identified components. For example, in English words, features include characters, phonemes, syllables, and combinations thereof.

In an exemplary CRF model, a first set of vertices Y in the graph represent a series of random variables representing possible values for features, such as characters, phonemes, or syllables, in a token. The vertices Y are referred to as a label sequence, with each vertex being one label in the label sequence. A second set of vertices X in the graph represent observed feature values from an observed token. For example, observed features in a token could be known characters, phonemes, and syllables that are identified in a standard token. A probability distribution of the label sequence Y is conditioned upon the observed values using conditional probability P(Y|X). In a common form of a CRF, a series of edges connect the vertices Y together in a linear arrangement that may be referred to as a chain. The edges between the vertices Y each represent one or more operations that are referred to as transition feature functions. In addition to the edges connecting the vertices Y, each vertex in the sequence of observed features X indexes a single vertex in the set of random variables Y. A second set of edges between corresponding observed feature vertices in X and the random variables in Y represent one or more operations that are referred to as observation feature functions.

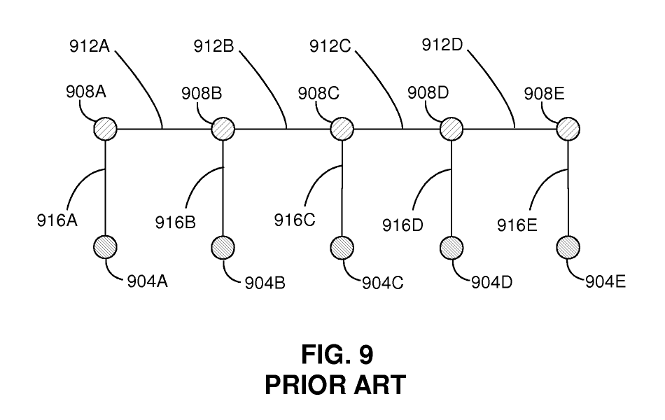

FIG. 9 depicts an exemplary structure of a prior art CRF. In FIG. 9, nodes 904A-904E represent a series of observed features X from a given token. Nodes 908A-908E represent a series of random variables representing a label sequence Y. Edges 912A-912D join the nodes 908A-908E in a linear chain. Each of the edges 912A-912D correspond to a plurality of transition feature functions that describe transitions between adjacent labels. The transition feature functions describe distributions of the random variables in the label sequence Y based on other labels in the label sequence and the observed sequence X. For example, a transition feature function ƒₑ may describe the probability of one character following another character in a token, such as the probability that the character “I” precedes the character “E” in a word. Due to the undirected nature of the CRF graph, the probability distributions for each of the random variables in the labels 908A-908D depend upon all of the other labels in the graph. For example, the probability distribution for labels 908B and 908C are mutually dependent upon one another, upon the labels 908A and 908D-908E, and upon the observed feature nodes 904A-904E.

The probability distribution of the label sequence Y is based on both the transitions between features within the labels in the sequence Y itself, as well as the conditional probability based on the observed sequence X. For example, if label 908B represents a probability distribution for an individual character in a token, the transition feature functions describe the probability distribution for the label 908B based on other characters in the label sequence, and the observation feature functions describe the probability distribution for the label 908B based on the dependence based on observed characters in the sequence X. The total probability distribution p(Y|X) of a label sequence Y that includes k labels conditioned upon an observed set X is provided by the following proportionality:

p(Y|X)∝e^{Σ}^{ₖ₌₁}^{ⁿ}^{[(Σ}^{ⱼ}^{λ} [symbol] ^{]}^{ⱼ}^{θ}^{ⱼ}^{(y}^{ₖ}^{,y}^{_{k−1}} [symbol] ^{X)+Σ}^{ᵢ}^{μ} [symbol] ^{ᵢ}^{g}^{ᵢ}^{(x}^{ₖ}^{,y}^{ₖ}^{,X))}

The functions ƒⱼ represent a series of transition feature functions between adjacent labels in the label sequence Y, such as the edges 912A-912D conditioned on the observed sequence X. The functions gᵢ represent a series of observation feature functions between the observed vertices 904A-904E and the labels 908A-908E, such as the edges 916A-916E. Thus, the conditional probability distribution for the label sequence Y is dependent upon both the transition feature functions and the observation feature functions. The terms λⱼ and μᵢ are a series of operational parameters that correspond to each of the transition feature functions ƒⱼ and observation feature functions gᵢ, respectively. Each of the operational parameters λⱼ and μᵢ is a weighted numeric value that is assigned to each of the corresponding transition feature functions and observation feature functions, respectively. As seen from the proportionality p(Y|X), as the value of an operational parameter increases, the total conditional probability associated with a corresponding transition feature function or observation feature function also increases. As described below, the operational parameters λⱼ and μᵢ are generated using a training set of predetermined standard tokens and corresponding non-standard tokens. The generation of the operational parameters 2 and μᵢ is also referred to as “training” of the CRF model.

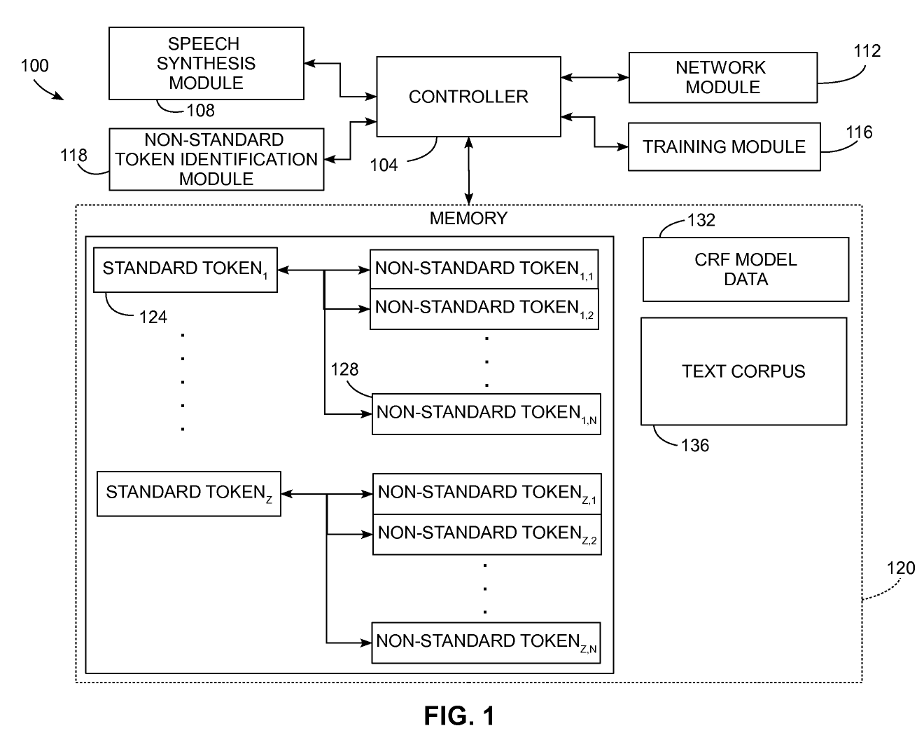

FIG. 1 depicts a token processing system 100 that is configured to generate parameters for a CRF model, and to apply the CRF model to a plurality of standard tokens to generate non-standard tokens that the CRF model indicates are likely to occur in text strings processed by the system 100. The system 100 includes a controller 104, speech synthesis module 108, network module 112, training module 116, non-standard token identification module 118, and a memory 120. The controller 104 is an electronic processing device such as a microcontroller, application specific integrated circuit (ASIC), field programmable gate array (FPGA), microprocessor including microprocessors from the x86 and ARM families, or any electronic device configured to perform the functions disclosed herein. Controller 104 implements software and hardware functional units, including speech synthesis module 108, network module 112, training module 116, and non-standard token identification module 118. One embodiment of the speech synthesis module includes audio digital signal processor (DSP) for generation of synthesized speech. Various embodiments of the network module 112 include a wired Ethernet adapter, a wireless network adaptor configured to access a wireless Local Area Network (LAN), such as an IEEE 802.11 network, and a wireless network adaptor configured to access a wireless wide area network (WAN), including 3G, 4G and any other wireless WAN network. In one configuration, the controller 104 performs the functions of training module 116 and non-standard token identification module 118 as a software program. As described below, the training module 116 generates parameters for the conditional random field model.

The controller 104 is operatively connected to the memory 120. Embodiments of the memory 120 include both volatile and non-volatile data storage devices including, but not limited to, static and dynamic random access memory (RAM), magnetic hard drives, solid state drives, and any other data storage device that enables the controller 104 to store data in the memory 120 and load data from the memory 120. The memory 120 includes a plurality of standard tokens 124. The speech synthesis module 108 is configured to generate an aural rendition of each of the standard tokens 124. In some embodiments, the standard tokens are generated using dictionaries corresponding to one or more languages for which the system 100 is configured to synthesize speech. The memory 120 stores a plurality of non-standard tokens in association with each standard token. In FIG. 1, a first group of non-standard tokens 128 are associated with one of the standard tokens 124. The non-standard tokens 128 are each a different variation of the corresponding standard token 124. For example, if the word “cause” is a standard token stored in the memory 120, various non-standard tokens stored in the memory 120 can include “kuz,” “cauz,” and “cus.”

In the example of FIG. 1, controller 104 is configured to generate a model of a conditional random field (CRF) from CRF model data 132 stored in the memory 120. The CRF model data 132 include a plurality of transition feature functions ƒⱼ and associated parameters λⱼ, and observation feature functions g, with associated parameters μᵢ. The controller 104 is configured to select a standard token from the plurality of standard tokens 124 in the memory 120, generate one or more non-standard tokens using the CRF model, and store the non-standard tokens in association with the selected standard token in the memory 120. The memory 120 further includes a text corpus 136. As described in more detail below, the controller 104 and training module 116 are configured to train the CRF model using standard tokens and non-standard tokens obtained from the text corpus 136.

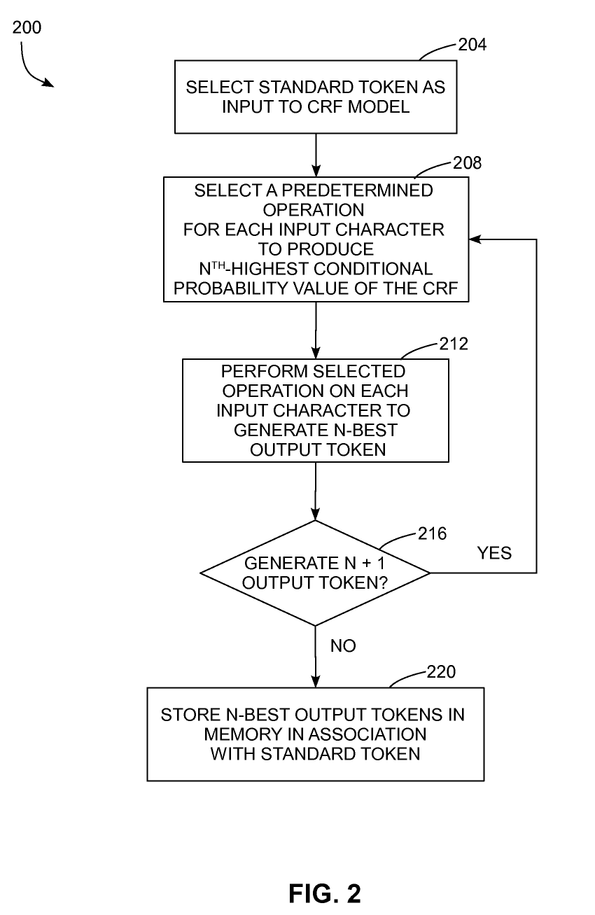

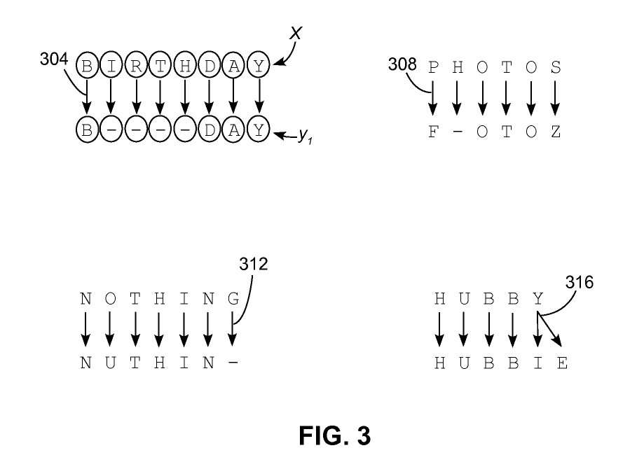

FIG. 2 depicts a process 200 for using a CRF model to generate a non-standard token using a plurality of input characters from a standard token, and FIG. 3 depicts examples of operations that may be performed on input characters from a standard token to generate non-standard tokens. Process 200 begins by selecting a standard token as an input to the CRF model (block 204). Using system 100 from FIG. 1 as an example, the controller 104 obtains one of the standard tokens 124 from the memory 120. Each of the characters in the standard token are observed features Kin the CRF graph. In FIG. 3, the standard token “BIRTHDAY” is depicted with each character in the token being shown as one of the nodes in the observed feature set X.

Once the standard token is selected, process 200 selects an operation to perform on each character in the standard token from a predetermined set of operations (block 208). The operations are chosen to produce an output token having the N^{th} highest conditional probability PQ^{'}) using the proportionality described above with the input features X and the CRF model using transition feature functions ƒⱼ(yₖ, yₖ₋₁, X), observation feature functions gᵢ(xₖ, yₖ, X), and operational parameters λⱼ and μᵢ. The N-best non-standard tokens are generated using a decoding or search process. In one embodiment, process 200 uses a combination of forward Viterbi and backward A* search to select a series of operations. These operations are then applied to the corresponding input characters in the standard token to generate an output token.

Once the operation for each of the input characters in the standard token is selected, process 200 performs the selected operations on the characters in the standard token to produce an output token. In process 200, the types of predetermined operations include replacing the input character with one other character in the non-standard token, providing the input character to the non-standard token without changing the input character, generating the output token without any characters corresponding to the input character, and replacing the input character with two predetermined characters.

Using English as an example language, the single character replacement operations include 676 (26²) operations corresponding to replacement of one input character that is a letter in the English alphabet with another letter from the English alphabet. As shown in FIG. 3, the single-letter replacement operation changes the letter “P” 308 in the standard token “PHOTOS” to the letter “F” in the non-standard output token “F-OTOZ.” Some non-standard tokens replace an alphabetic letter with a numeric character or other symbol, such as a punctuation mark. The operation to provide a character in the input token to the output token unchanged is a special-case of the single character replacement operation. In the special case, the input character corresponds to an output character having the same value as the input character. In FIG. 3, the character “B” 304 in the standard token “BIRTHDAY” corresponds to the equivalent character “B” in the output token “B----DAY.”

Another special-case for the single character replacement operation occurs when an input character in the standard token is omitted from the output token. An operation to omit an input character from the output token can be characterized as converting the input character to a special “null” character that is subsequently removed from the generated output token. As shown in FIG. 3, the character “G” 312 in the standard token “NOTHING” is converted to a null character, signified by a “-” symbol, in the output token “NUTHIN-.”

Process 200 includes a predetermined selection of operations for generating a combination of two characters, referred to as a digraph, in the output token from a single character in the standard token. Using English standard tokens as an example, a single input character can be replaced by the combinations of “CK,” “EY,” “IE,” “OU,” and “WH,” which are selected due to their frequency of use in English words and in non-standard forms of standard English tokens. Alternative embodiments of process 200 include operations to generate different digraphs from a single input character, and also generate combinations of three or more characters that correspond to a single input character. As shown in FIG. 3, the input character “Y” 316 in the standard token “HUBBY” is replaced by a selected digraph “TE” in the output token “HUBBIE.”

Process 200 generates a plurality of non-standard tokens corresponding to a single standard token. Since multiple non-standard variations for a single standard token can occur in different text messages, process 200 can continue to generate N predetermined non-standard tokens that correspond to the standard token (block 216). The operations to generate each successive non-standard token are selected to have the N^{th} highest conditional probability p(Y|X) for the provided standard token and the CRF model. In one embodiment, process 200 generates twenty non-standard output tokens that correspond to the standard token, corresponding to the twenty highest conditional probability values identified for the CRF model and the characters in the standard token. Process 200 stores each of the output tokens in memory in association with the standard token (block 220). Each output token may be stored in memory at any time after the output token is generated. As seen in FIG. 1, the N non-standard tokens 128 are associated with one of the standard tokens 124. The non-standard tokens are stored in an array, database, lookup table, or in any arrangement that enables identification of each non-standard token and the associated standard token.

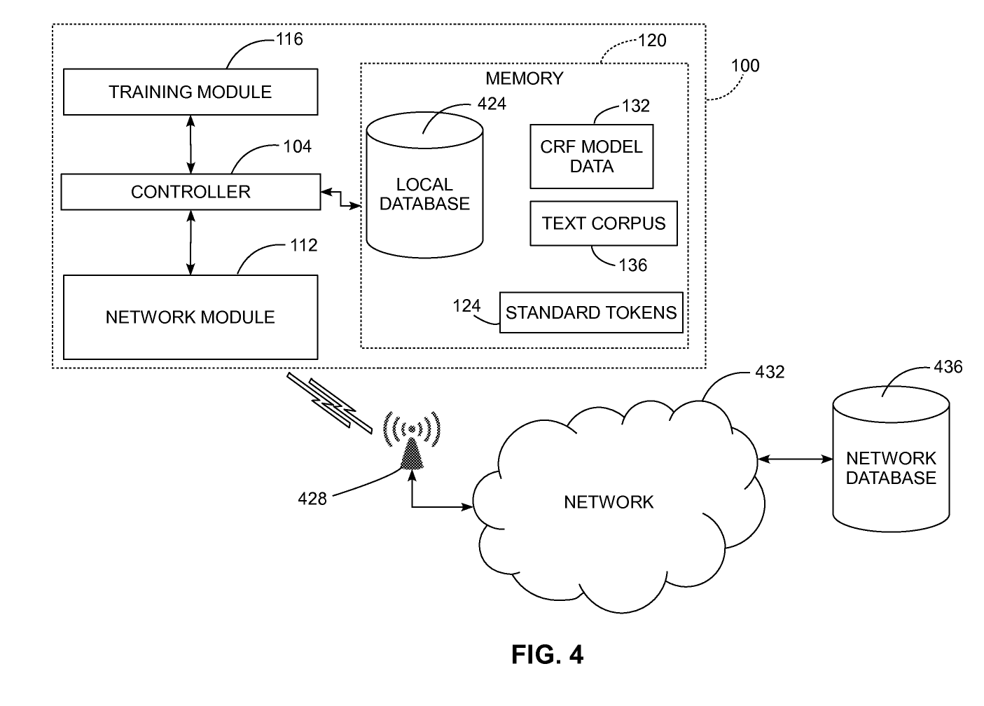

FIG. 4 depicts a configuration of the system 100 for generation of the operational parameters λⱼ and μᵢ for the CRF model used to generate non-standard tokens from the standard tokens. In the configuration of FIG. 4, controller 104 executes programmed instructions provided by the training module 116 to generate the operational parameters λⱼ and μᵢ. To generate the operational parameters λⱼ and μᵢ, the controller 104 identifies non-standard tokens in text corpus 136 and then identifies standard tokens corresponding to the non-standard tokens. Each of the non-standard tokens is paired with a corresponding standard token. The operational parameters of the CRF model data 132 are generated statistically using the pairs of corresponding non-standard and standard tokens. Once the operational parameters λⱼ and μᵢ are generated, the CRF model is “trained” and can subsequently generate non-standard tokens when provided with standard tokens. Once trained, at least a portion of the non-standard tokens that are generated in accordance with the CRF model are different from any of the non-standard tokens presented in the text corpus 136.

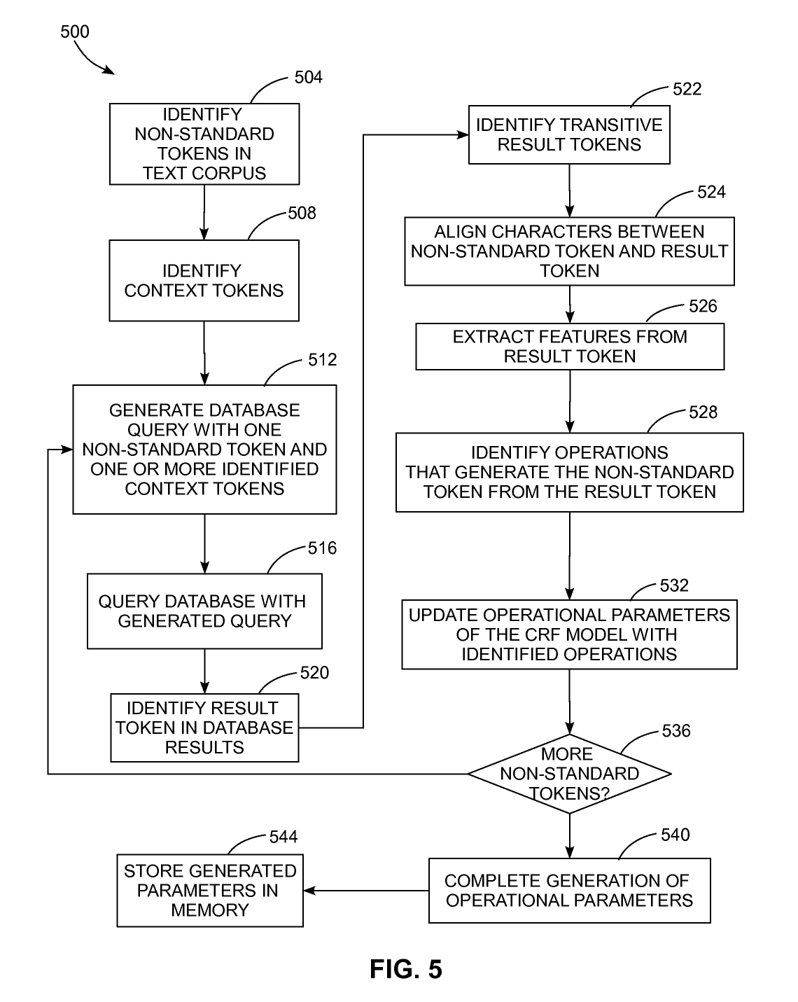

FIG. 5 depicts a process 500 for generating pairs of non-standard and standard tokens and for generation of the operational parameters λⱼ and μᵢ in the CRF model. The configuration of system 100 depicted in FIG. 4 performs the process 500. Process 500 begins by identifying a plurality of non-standard tokens in a text corpus (block 504). The source of the text corpus is selected to include a sufficient number of relevant standard tokens and non-standard tokens to enable generation of representative operational parameters for the CRF model. For example, a collection of text messages written by a large number of people who are representative of the typical users of the system 100 contains relevant non-standard tokens. In system 100, the controller 104 compares the tokens in text corpus 136 to the standard tokens 124. Non-standard tokens in the text corpus 136 do not match any of the standard tokens 124. In practical embodiments, the standard tokens 124 are arranged for efficient searching using hash tables, search trees, and various data structures that promote efficient searching and matching of standard tokens. In system 100, each of the standard tokens in the text corpus 136 matches a standard token 124 stored in the memory 120.

To eliminate typographical errors from consideration, process 500 identifies a single non-standard token only if the number of occurrences of the non-standard token in the text corpus exceeds a predetermined threshold. Process 500 also identifies context tokens in the text corpus (block 508). As used herein, the term “context token” refers to any token other than the identified non-standard token that provides information regarding the usage of the non-standard token in the text corpus to assist in identification of a standard token that corresponds to the non-standard token. The context tokens information about the non-standard token that is referred to as “contextual information” since the context tokens provide additional information about one or more text messages that include the non-standard token. The context tokens can be either standard or non-standard tokens.

Process 500 generates a database query for each of the non-standard tokens (block 512). In addition to the non-standard token, the database includes one or more of the context tokens identified in the text corpus to provide contextual information about the non-standard token. The database query is formatted for one or more types of database, including network search engines and databases configured to perform fuzzy matching based on terms in a database query. In FIG. 4, the system 100 includes a local database 424 stored in the memory 120 that is configured to receive the database query and generate a response to the query including one or more tokens. The system 100 is also configured to send the database query using the network module 112. In a typical embodiment, the network module 112 transmits the query wirelessly to a transceiver 428. A data network 432, such as the Internet, forwards the query to an online database 436. Common examples of the online database are search engines such as search engines that search the World Wide Web (WWW) and other network resources. The system 100 is configured to perform multiple database queries concurrently to reduce the amount of time required to generate database results. Multiple concurrent queries can be sent to a single database, such as the online database 436, and concurrent queries can be sent to multiple databases, such as databases 424 and 436, simultaneously.

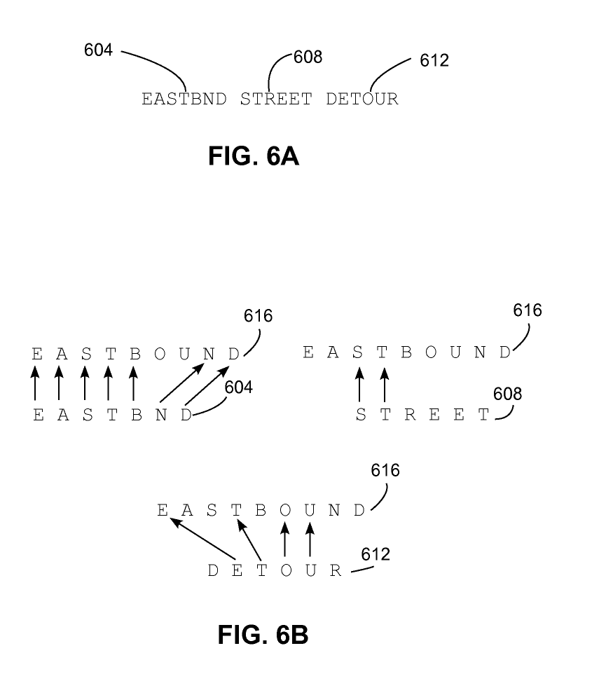

FIG. 6A depicts a database query where a non-standard token 604 and context tokens 608 and 612 are search terms for a search engine. The query includes the non-standard token “EASTBND” 604. The context tokens “STREET” 608 and “DETOUR” 612 are selected from the text corpus and are included in the database query. In one embodiment, the selected context tokens are located near the non-standard token in a text message that includes the non-standard token to provide contextual information for the non-standard token. For example, the standard tokens 608 and 612 may be in the same sentence or text message as the non-standard token 604.

Process 500 queries the selected database with the generated query (block 516). The database generates a query result including one or more tokens. When querying a network database 436, the result is sent via network 432 and wireless transceiver 428 to the system 100.

In some embodiments, the system 100 generates multiple database queries for each non-standard token. Each of the database queries includes a different set of context tokens to enable the database to generate different sets of results for each query.

Process 500 identifies a token, referred to as a result token, from one or more candidate tokens that are present in the results generated by the database (block 520). The results of the database query typically include a plurality of tokens. One of the tokens may have a value that corresponds to the non-standard token used in the query. When the network database 436 is a search engine, the results of the search may include tokens that are highlighted or otherwise marked as being relevant to the search. Highlighted tokens that appear multiple times in the results of the search are considered as candidate tokens.

Process 500 filters the candidate tokens in the database result to identify a result token from the database results. First, candidate tokens that exactly match either the non-standard token or any of the context tokens included in the database query are removed from consideration as the result token. Each of the remaining candidate tokens is then aligned with the non-standard token and the context tokens in the database query along a longest common sequence of characters. As used herein, the term “longest common sequence of characters” refers to a sequence of one or more ordered characters that are present in the two tokens under comparison where no other sequence of characters common to both tokens is longer. Candidate tokens that have longest common sequences with a greater number of characters in common with any of the context tokens than with the non-standard token are removed from consideration as a result token. If the candidate token does not match any of the tokens provided in the database query and its longest common character sequence with the non-standard token is greater than a pre-defined threshold, the candidate token is identified as a result token corresponding to the non-standard token.

FIG. 6B depicts a candidate token “EASTBOUND” aligned along the longest common sequence of characters with the tokens depicted in FIG. 6A. The token “EASTBOUND” is not a direct match for any of the database query terms 604, 608, and 612. As shown in FIG. 6B, the two context tokens 608 and 612 have longest common character sequence of two and four characters respectively with the candidate token 616, while the non-standard token 604 has a longest common sequence of seven characters. Once identified, the result token is stored in memory in association with the non-standard token. The training data used to train the CRF model includes multiple pairings of result tokens with non-standard tokens.

Referring again to FIG. 5, process 500 identifies transitive results that may correspond to the identified non-standard token and result token (block 522). Transitive results refer to a condition where a result token is also a non-standard token, and another non-standard token having an equivalent value corresponds to a standard token. For example, a first result-token non-standard token pair is (cauz, cuz), while a second result token non-standard token pair is (cause, cauz). The result token “cauz” in the first pair is a non-standard token, and the second pair associates “cauz” with the standard token “cause.” Process 500 associates the non-standard token “cuz” with the transitive standard result token “cause.” The transitive association between non-standard result tokens enables process 500 to identify standard tokens for some non-standard tokens when the corresponding result tokens in the database query are also non-standard tokens.

Process 500 aligns linguistically identifiable components of the non-standard token with corresponding components in the result token (block 524). The components include individual characters, groups of characters, phonemes, and/or syllables that are part of the standard token. Alignment between the non-standard token and the result token along various components assists in the generation of the operational parameters μᵢ for the observation feature functions gᵢ. In one embodiment, the standard token and non-standard token are aligned on the character, phonetic, and syllable levels as seen in Table 1. Table 1 depicts an exemplary alignment for the standard token EASTBOUND with non-standard token EASTBND. The features identified in Table 1 are only examples of commonly identified features in a token. Alternative embodiments use different features, and different features can be used when analyzing tokens of different languages as well. In Table 1, the “-” corresponds to a null character

TABLE 1
Alignment of Features Between Standard
and Non-Standard Tokens

| | | | | | | | | | |
|---|---|---|---|---|---|---|---|---|---|
| Result Token | E | A | S | T | B | O | U | N | D |
| Current Character | E | A | S | T | B | O | U | N | D |
| Next Character | A | S | T | B | O | U | N | D | -- |
| Next Two | AS | ST | TB | BO | OU | UN | ND | D-- | -- -- |
| Characters | | | | | | | | | |
| Current Phoneme | I: | I: | S | T | B | A [symbol] | A [symbol] | N | D |
| Next Phoneme | S | S | T | B | A [symbol] | A [symbol] | N | D | -- |
| Vowel? | Y | Y | N | N | N | Y | Y | N | N |
| Begins Syllable? | Y | N | N | N | Y | N | N | N | N |
| Non-Standard | E | A | S | T | B | -- | -- | N | D |
| Token | | | | | | | | | |

In Table 1, each of the columns includes a vector of features that correspond to a single character in the standard token and a corresponding single character in the non-standard token. For example, the character “O” in the standard token has a set of character features corresponding to the character “O” itself, the next character “U”, and next two characters “OU.” The letter O in EASTBOUND is part of the phoneme Aυ, with the next phoneme in the token being the phoneme N as defined in the International Phoneme Alphabet (IPA) for English. Table 1 also identifies the character “O” as being a vowel, and identifies that O is not the first character in a syllable. Process 500 extracts the identified features for each of the characters in the standard token into a feature vector (block 526). The features in the feature vector identify a plurality of observed features in the result token that correspond to the pairing between one character in the result token and one or more corresponding characters in the non-standard token.

Process 500 identifies the operations that are performed on characters in the result token that generate the non-standard token once the features are extracted (block 528). Referring again to Table 1, some characters in the result token “EASTBOUND” are also present in the non-standard token “EASTBND.” Unchanged characters correspond to a single-character operation where an input character in the result token is associated with a character having an equivalent value in the non-standard token. The characters “OU” in the result token 616 map to a null character in the non-standard token 604.

As described above, each operation between the result token 616 and the non-standard token 604 corresponds to a vector of observation feature functions g, with corresponding operational parameters μᵢ. When one particular observation function is present in the training data pair, the corresponding value for μᵢ is updated to indicate that the given observation feature function occurred in the training data. For example, one feature function g_{E-E} describes the operation for converting the input character “E” in the result token 616 to the output character “E” in the non-standard token 604. The value of the corresponding operational parameter μ_{E-E} is updated when the operation corresponding to the function g_{E-E} is observed in the training data. When one particular transition function ƒⱼ is present between characters in the non-standard token 604, the value for the corresponding operational parameter λⱼ is updated (block 532). The updates to the operational parameter values are also made with reference to the feature vectors associated with each character in the result token. The weights of the values λⱼ for the transition functions ƒⱼ are updated in a similar manner based on the identified transitions between features in the non-standard token.

In one embodiment, the CRF training process 500 uses the limited-memory Broyden-Fletcher-Goldfarb-Shanno (L-BFGS) algorithm and the identified pairs of non-standard tokens and corresponding standard tokens to calculate the parameters λⱼ and μᵢ using the extracted features from the training data. The operational parameters λⱼ and μᵢ are stored in a memory in association with the corresponding transition feature functions ƒⱼ and observation feature functions gᵢ (block 544). In system 100, the operational parameters λⱼ and μᵢ are stored in the CRF model data 132 in the memory 112. The system 100 uses the generated CRF model data 132 to generate the non-standard tokens from standard tokens as described in process 200.

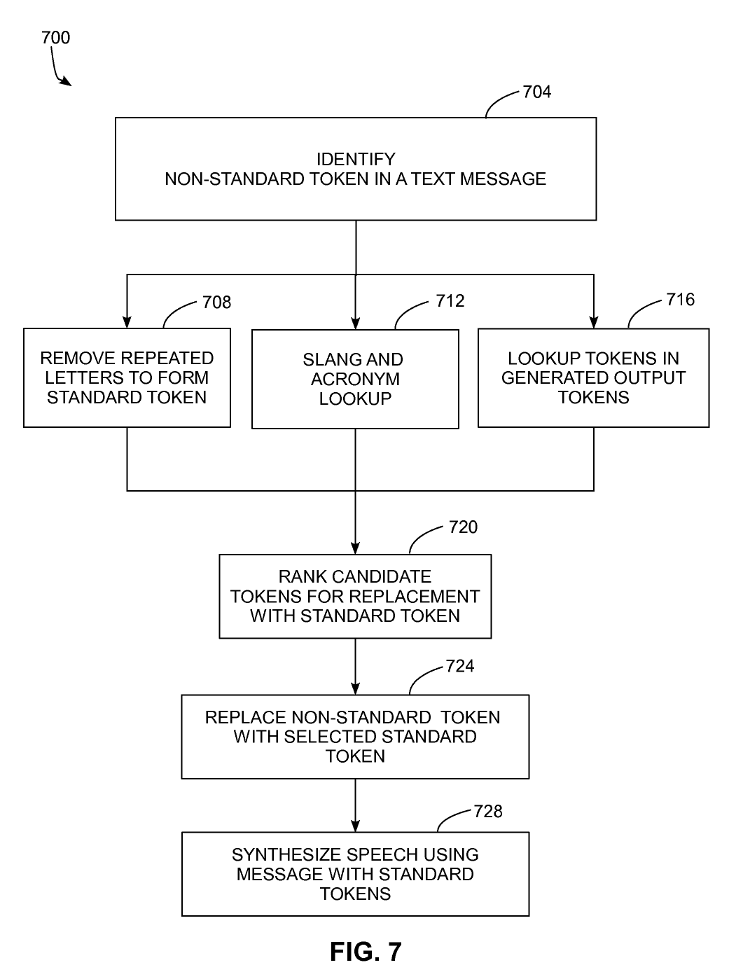

FIG. 7 depicts a process 700 for replacement of a non-standard token in a text message with a standard token. System 100 as depicted in FIG. 1 is configured to perform process 700 and is referred to by way of example. Process 700 begins by identification of non-standard tokens in a text message (block 704). In system 100, the network module 112 is configured to send and receive text messages. Common forms of text messages include SMS text messages, messages received from social networking services, traffic and weather alert messages, electronic mail messages, and any electronic communication sent in a text format. The text messages often include non-standard tokens that the controller 104 identifies by identifying tokens that have values that do not match any of the standard tokens 124. In system 100, a non-standard token identification module 118 is configured to identify tokens in the text message and supply the tokens to the controller 104 for matching with the standard tokens 124.

Process 700 includes three sub-processes to identify a standard token that corresponds to the identified non-standard token. One sub-process removes repeated characters from a non-standard token to determine if the resulting token matches a standard token (block 708). Another sub-process attempts to match the non-standard token to slang tokens and acronyms stored in the memory (block 712). A third sub-process compares the non-standard token to the plurality of non-standard tokens that correspond to each of the standard tokens in the memory (block 716). The processes of blocks 708-716 can be performed in any order or concurrently. In system 100, the controller 104 is configured to remove repeated characters from non-standard tokens to determine if the non-standard tokens match one of the standard tokens 124. Additionally, slang and acronym terms are included with the standard tokens 124 stored in the memory 112. In an alternative configuration, a separate set of slang and abbreviation tokens are stored in the memory 112. Controller 104 is also configured to compare non-standard tokens in the text message to the non-standard tokens 128 to identify matches with non-standard tokens that correspond to the standard tokens 124.

Some non-standard tokens correspond to multiple standard tokens. In one example, the non-standard token “THKS” occurs twice in the set of non-standard tokens 128 in association with the standard tokens “THANKS” and “THINKS”. Each of the standard tokens is a candidate token for replacement of the non-standard token. Process 700 ranks each of the candidate tokens using a statistical language model, such as a unigram, bigram, or trigram language model (block 720). The language model is a statistical model that assigns a probability to each of the candidate tokens based on a conditional probability generated from other tokens in the text message. For example, the message “HE THKS IT IS OPEN” includes the “HE” and “IT” next to the non-standard token “THKS.” The language model assigns a conditional probability to each of the tokens “THANKS” and “THINKS” that corresponds to the likelihood of either token being the correct token given that the token is next to a set of known tokens in the text message. The standard tokens are ranked based on the probabilities, and the standard token that is assigned the highest probability is selected as the token that corresponds to the non-standard token.

Process 700 replaces the non-standard token with the selected standard token in the text message (block 724). In text messages that include multiple non-standard tokens, the operations of blocks 704-724 are repeated to replace each non-standard token with a standard token in the text message. The modified text message that includes only standard tokens is referred to as a normalized text message. In process 700, the normalized text message is provided as an input to a speech synthesis system that generates an aural representation of the text message (block 728). In system 100, the speech synthesis module 108 is configured to generate the aural representation from the standard tokens contained in the normalized text message. Alternative system configurations perform other operations on the normalized text message, including language translation, grammar analysis, indexing for text searches, and other text operations that benefit from the use of standard tokens in the text message.

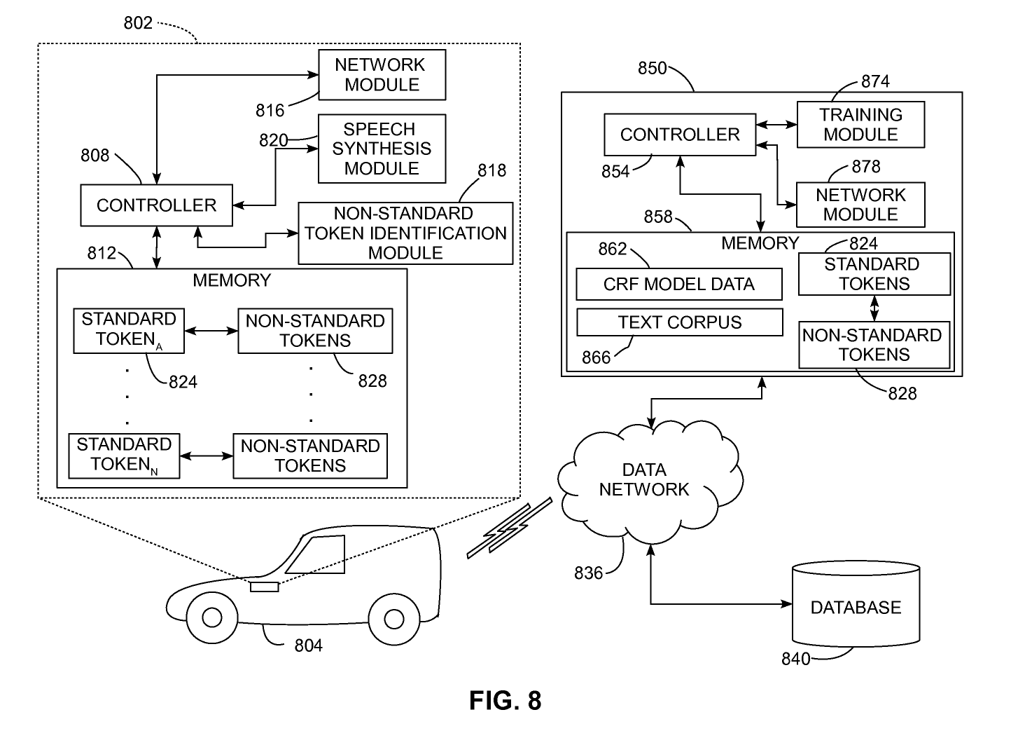

FIG. 8 depicts an alternative configuration of the system 100 that is provided for use in a vehicle. A language analysis system 850 is operatively connected to a communication and speech synthesis system 802 in a vehicle 804. The language analysis system 850 generates a plurality of non-standard tokens that correspond to a plurality of standard tokens, and the system 802 is configured to replace the non-standard tokens in text messages with the standard tokens prior to performing speech synthesis.

The language analysis system 850 includes a controller 854, memory 858, training module 874 and network module 878. The memory 858 stores CRF model data 862, text corpus 866, a plurality of standard tokens 824 and non-standard tokens 828. The controller 854 is configured to generate the CRF model data using process 500. In particular, the network module 878 sends and receives database queries from a database 840, such as an online search engine, that is communicatively connected to the network module 878 through a data network 836. The controller 854 operates the training module 874 to generate training data for the CRF model using the text corpus 866. The controller 854 and training module 874 generate CRF model data 862 using the training data as described in process 500. The language analysis system 850 is also configured to perform process 200 to generate the non-standard tokens 828 from the standard tokens 824 using a CRF model that is generated from the CRF model data 862. The standard tokens 824 and corresponding non-standard tokens 828 are provided to one or more in-vehicle speech synthesis systems, such as the communication and speech synthesis system 802 via the network module 878.

A vehicle 804 includes a communication and speech synthesis system 802 having a controller 808, memory 812, network module 816, non-standard token identification module 818, and speech synthesis module 820. The memory 812 includes the plurality of standard tokens 824 that are each associated with a plurality of non-standard tokens 828. The system 802 receives the standard tokens 824 and associated non-standard tokens 828 from the language analysis system 850 via the data network 836. The controller 808 is configured to replace non-standard tokens with standard tokens in text messages from the standard tokens 824 in the memory 812. The system 802 receives the standard tokens 824 and associated non-standard tokens 828 from the language analysis system 850 via the network module 816. System 802 identifies non-standard tokens in text messages using the non-standard token identification module 818 and generates synthesized speech corresponding to normalized text messages using the speech synthesis module 820 as described above in process 700. While the system 802 is depicted as being placed in vehicle 804, alternative embodiments place the system 802 in a mobile electronic device such as a smart phone.

In the configuration of FIG. 8, the language analysis system is configured to continually update the text corpus 866 using selected text messages that are sent and received from multiple communication systems such as system 802. Thus, the text corpus 866 reflects actual text messages that are sent and received by a wide variety of users. In one configuration, the text corpus 866 is configured to receive updates for an individual user to include messages with non-standard tokens that are included in text messages sent and received by the user. For example, the text corpus 866 can be updated using text messages sent and received by the user of vehicle 804. Consequently, the text corpus 866 includes non-standard tokens more typically seen by the individual user of the vehicle 804 and the non-standard tokens 828 are generated based on text messages for the individual user. The system 850 is configured to store text corpora and generate individualized non-standard token data for multiple users.

In operation, the language analysis system 850 is configured to update the CRF model data 862 periodically by performing process 500 and to revise the non-standard tokens 828 using the CRF data model. The communication and speech synthesis system 802 receives updates to the standard tokens 824 and non-standard tokens 828 to enable improved speech synthesis results.

It will be appreciated that variants of the above-disclosed and other features and functions, or alternatives thereof, may be desirably combined into many other different systems, applications or methods. For example, while the foregoing embodiments are configured to use standard tokens corresponding to English words, various other languages are also suitable for use with the embodiments described herein. Various presently unforeseen or unanticipated alternatives, modifications, variations or improvements may be subsequently made by those skilled in the art that are also intended to be encompassed by the following claims.

What is claimed is:

1. A method for generating non-standard tokens from a standard token stored in a memory comprising:
selecting a standard token from a plurality of standard tokens stored in the memory, the selected token having a plurality of input characters;
selecting an operation from a plurality of predetermined operations in accordance with a random field model for each input character in the plurality of input characters;
performing the selected operation on each input character to generate an output token that is different from each token in the plurality of standard tokens; and
storing the output token in the memory in association with the selected token.

2. The method of claim 1, the operation performed on each input character being one of:
providing the input character in the output token;
replacing the input character with one different character in the output token;
replacing the input character with a plurality of different characters in the output token; and
not providing the input character in the output token.

3. The method of claim 1 wherein the random field model is a conditional random field model.

4. The method of claim 3 further comprising:
generating a plurality of operational parameters for the conditional random field model prior to generating the output token, the generation of the plurality of operational parameters for the conditional random field model comprising:
comparing each token in a second plurality of tokens stored in the memory to the standard tokens in the plurality of standard tokens;
identifying a first token in the second plurality of tokens as being a non-standard token in response to the first token being different from each of the tokens in the plurality of standard tokens;
identifying a second token in the second plurality of tokens as being a context token in response to the second token providing contextual information for the first token;
generating at least one database query, the at least one database query including the first token and the second token;
querying a database with the at least one generated database query; and
identifying a result token corresponding to the first token from a result obtained from the database.

5. The method of claim 4, wherein the database is a search engine, the first token and the second token being search terms for the search engine.

6. The method of claim 4, the generation of the plurality of operational parameters for the conditional random field model further comprising:
aligning each character in the result token with at least one character in the non-standard token;
identifying at least one feature in the result token corresponding to each character in the result token;
identifying an operation in the plurality of predetermined operations that generates at least one character in the non-standard token from a corresponding aligned character in the result token; and
updating the operational parameters of the conditional random field model with reference to the identified operation and the at least one feature of the aligned character in the result token.

7. The method of claim 4 further comprising:
generating a plurality of non-standard tokens for the selected standard token, at least some of the plurality of non-standard tokens being different from each token in the second plurality of tokens; and
storing the plurality of non-standard tokens in the memory in association with the selected standard token.

8. The method of claim 1, further comprising:
identifying a non-standard token in a text message having at least one token, the non-standard token corresponding to a non-standard token stored in the memory;
obtaining a standard token that is associated with the non-standard token from the memory;
replacing the non-standard token in the text message with the standard token; and
synthesizing speech corresponding to the at least one standard token in the text message.

9. The method of claim 8 further comprising:
identifying a plurality of standard tokens stored in the memory that are associated with the non-standard token;
applying a rank to each of the standard tokens that are associated with the non-standard token, the rank being a probability of each standard token appearing in the text message; and
replacing the non-standard token with a standard token in the plurality of standard tokens having a highest rank.

10. A method for generating operational parameters for use in a random field model comprising:
comparing each token in a first plurality of tokens stored in a memory to a plurality of standard tokens stored in the memory;
identifying a first token in the first plurality of tokens as a non-standard token in response to the first token being different from each standard token in the plurality of standard tokens;
identifying a second token in the first plurality of tokens as a context token in response to the second token providing contextual information for the first token;
generating a database query including the first token and the second token;
querying a database with the generated query;
identifying a result token corresponding to the first token from a result obtained from the database; and
storing the result token in association with the first token in a memory.

11. The method of claim 10, the result token being different from the second token.

12. The method of claim 10, the identification of the result token further comprising:
identifying a first longest common sequence of characters in the first token and in a candidate token in the result obtained from the database;
identifying a second longest common sequence of characters in the second token and in the candidate token; and
identifying the candidate token as the result token in response to the first longest common sequence of characters having a greater number of characters than the second longest common sequence characters.

13. The method of claim 10 further comprising:
identifying a first candidate token corresponding to the first token in the result obtained from the database, the first candidate token being a non-standard token;
identifying a second candidate token corresponding to the first candidate token, the second candidate token matching a token in the second plurality of standard tokens stored in the memory; and
storing the second candidate token in association with the first token in the memory.

14. A system for generating non-standard tokens from standard tokens comprising:
a memory, the memory storing a plurality of standard tokens and a plurality of operational parameters for a random field model; and
a processing module operatively connected to the memory, the processing module being configured to:
obtain the operational parameters for the random field model from the memory;
generate the random field model from the operational parameters;
select a standard token from the plurality of standard tokens in the memory, the selected standard token having a plurality of input characters;
select an operation from a plurality of predetermined operations in accordance with the random field model for each input character in the plurality of input characters for the selected standard token;
perform the selected operation on each input character in the selected standard token to generate an output token that is different from each standard token in the plurality of standard tokens; and
store the output token in the memory in association with the selected standard token.

15. The system of claim 14, the selected operation being one of:
providing the input character to the output token;
replacing the input character with one different character in the output token;
replacing the input character with a plurality of different characters in the output token; and
deleting the input character in the output token.

16. The system of claim 14 wherein the random field model is a conditional random field model.

17. The system of claim 16 further comprising:
a training module configured to generate the operational parameters for the conditional random field model, the training module being operatively connected to the memory and configured to:
compare each token in a second plurality of tokens stored in the memory to the standard tokens in the plurality of standard tokens stored in the memory;
identify a first token in the second plurality of tokens as a non-standard token in response to the first token being different from each standard token in the plurality of standard tokens;
identify a second token in the second plurality of tokens as a context token in response to the second token providing contextual information for the first token;
generate a database query including the first token and the second token;
query a database with the generated database query;
identify a result token corresponding to the first token from a result obtained from the database in response to the database query; and
store the first token in the memory in association with the result token.

18. The system of claim 17, the training module being further configured to query a search engine with the generated database query.

19. The system of claim 17, the training module being further configured to:
align each character in the result token with at least one character in the first token;
identify at least one feature in the result token corresponding to each character in the result token;
identify an operation in the plurality of predetermined operations that generates at least one character in the first token from a corresponding aligned character in the result token; and
update the operational parameters of the conditional random field model with reference to the identified operation and the at least one feature of the aligned character in the result token.

20. The system of claim 14 further comprising:
a speech synthesis module; and
a non-standard token identification module operatively connected to the memory and the speech synthesis module, the non-standard token identification module being configured to identify a non-standard token in a text message stored in the memory, the non-standard token in the text message corresponding to a standard token stored in the memory, replace the non-standard token in the text message with the standard token, and provide the text message to the speech synthesis module for speech synthesis.
